(19) United States
(12) Patent Application Publication
(10) Pub. No.: US 2008/0173340 A1
(43) Pub. Date: Jul. 24, 2008

(54) Hand grip for crutches, walkers, canes and other ambulatory devices

(76) Inventor: Johnnie Robbins, Amarillo, TX (US)

Correspondence Address: SAMUEL BROWN SILVERMAN, 510 SOUTH POLK STREET, AMARILLO, TX, 79101-2318, US

(21) Appl. No.: 11/388,150

(22) Filed: Mar. 24, 2006

(51) Int. Cl. A61H 3/02

(52) U.S. Cl. 135/72

(57) ABSTRACT

An improved hand grip for crutches, walkers, canes and other ambulatory devices consists of a body portion and at least one attachment element. The body portion has a base, an upper exterior surface, a generally convex region, and at least one concavity. The at least one attachment element attaches the body portion to the support structure of the crutch, walker, cane and other ambulatory device. The method for traveling along a walking surface includes positioning the heel of the palm region on the base of a hand of an operator upon the body portion, whereby the operator contacts the body portion with the base of his hand and the operator supports himself by engaging the heel of the palm region on the base of a hand on the body portion while walking.

### 1. FIELD OF THE INVENTION

The present invention is directed, in certain embodiments, to hand grips for ambulation aids such as crutches, walkers and canes.

### 2. DISCLOSURE DOCUMENT FILING REFERENCE

This invention was the subject of U.S. Patent Office Disclosure Document Number 526521, filed Feb. 20, 2003.

### 3. BACKGROUND OF THE INVENTION

Ambulation aids, such as crutches, walkers, and canes employ hand grips, which are commonly cylindrically-shaped. These conventional hand grips are usually made of hard plastic or soft pliable plastic or have foam padding around a tubular core. These conventional hand grips are the source of discomfort, primarily because much of the force employed by an operator in supporting the body and much of the force transferred along the crutch are both transferred through an operator's hands at the hand grips. The exterior surface of the cylindrically-shaped hand grips generally engage the hand of the operator between the thumb and forefinger.

Conventional cylindrical hand grips concentrate pressure on the valor aspect of the palm and the adductor pollicis muscles located in the web of the hand between the thumb and the forefinger. Concentrating pressure on this area of the hand results in the compression of the median, ulnar and palmar nerves, as well as the ulnar and palmar arteries. Such compression restricts the blood flow and results in nerve entrapment syndromes, specifically carpal tunnel syndrome. Prolonged excessive loading in the region of the adductor pollis muscles can result in injury to the proper palmar digital nerves of the thumb and the flexor pollicis longus tendon.

Additionally, conventional cylindrical hand grips do not properly axially align the hand and wrist of the ulna and radius bones of the arm. By promoting dorsal flexation of the wrist, the grasping of the conventional cylindrical hand grip results in increased tensional stress on the tendons, nerves and blood vessels on the palmar side of the wrist; the wedge-shaped anticular disc of cartilage separating the radius and ulna bones of the arm is forced from the lunate and scaphoid bones of the wrist into the interface between the arm and the wrist. The compression of the disc forces the bones apart and places compressive stress on the radial, medial, and ulnar nerves, blood vessels and ligaments.

Misalignment of the wrist and arm is particularly exacerbated by ambulation devices employing cylindrical hand grips, as the elongated support member is frequently at an acute angle to the vertical. As the entire weight of the operator is frequently placed on the hands, while the crutch shafts are disposed in an acute angle to the vertical, an operator is susceptible to injuries to the hands and wrists.

After an operator experiences the discomfort and fatigue from using the conventional cylindrical hand grips in ambulation devices, the degeneration of skin, nerves, tendons, and cartilage in the hands and wrists follows, as do fatigue, loss of strength and pain.

Currently, the commonly employed hand grips for ambulation aids, such as crutches, walkers, and canes, do not address these problems.

### 4. DESCRIPTION OF RELEVANT PRIOR ART PATENTS

Hand grips for ambulation aids, such as crutches, walkers, canes, and other ambulatory devices in certain prior art embodiments describe and claim specific structures for varied purposes.

U.S. Pat. No. 5,339,850 (Mertz) describes an orthopedic hand grip for ambulation aids, tools and other implements. This elongated, generally cylindrical hand grip has an elongated body, the longitudinal axis of which extends outwardly and transverse to the support member of the ambulation aid. The contoured shape of the hand grip, the indentations for the fingers at an oblique angle with respect to the longitudinal axis of the support member prevent rotation of the hand about a longitudinal axis of the body and maintain the wrist and arm of the user in axial alignment with the support member.

U.S. Pat. No. 5,155,878 (Dellis) describes a moldable hand grip. This elongated, generally cylindrical hand grip has an elongated body. The moldable shape of the hand grip, permits for the individualized shaping of the grip to the palm and fingers of a particular operator.

U.S. Pat. No. 5,009,416 (Caruthers) describes a grip-facilitating handle. An operator's hand fits into a chamber, and the palm of the operator rests on a convex inner surface. The handle is disposed radially outward from an existing handle. In use, the operator's hand is maintained at a naturally curved, at rest position, and a forceful grip is not necessary, thus reducing fatigue.

U.S. Pat. No. 4,151,853 (Inbar) describes a crutch construction with a hand rest designed to be engaged by the peripheral portions of the palm of an operator's hand. This hand rest avoids the requirement of the user curling his fingers around the hand rest is gripping relation in the bar-type grip. The hand rest includes a ball element, which fits into a socket for universal movement.

### 5. SUMMARY OF THE INVENTION

This invention presents a type of hand grip for a crutch, a walker, a cane and other ambulatory device and method of use which provides ease of operation and decreases the damage to an operator's hands by employing a minimum of components in the apparatus and a minimum of contact on surface area of an operator's hands.

This invention is an improved hand grip for a crutch, a walker, a cane and other ambulatory device, consisting of a body portion and an attachment means. The body portion includes a base, an upper exterior surface, a generally convex region, and at least one concavity on the upper exterior surface.

The base of the body portion has a front, a rear, at least one side, a first longitudinal axis, and an underside. The upper exterior surface of the body portion has a first region attached to the rear of the base and a second region attached to the at least one side of the base, and a third region attached to the front of the base. The generally convex region of the body portion is bounded by the rear of the base, at least one side of the base, and the front of the base. The generally convex region of the body portion further includes the first region of the upper exterior surface, the second region of the upper exterior surface and the third region of the upper exterior surface. The at least one concavity on the upper exterior surface is located between the first region of the upper exterior surface, the second region of the upper exterior surface, and the third region of the upper exterior surface.

The attachment means is attached to the base for fixably attaching the body portion to at least one support structure of a crutch, a walker, a cane or other ambulatory device.

In other embodiments, the base is elongated along the first longitudinal axis, and the underside of the base of the body portion is contoured, and in some embodiments the contoured underside receives at least one finger of an operator.

In yet other embodiments, the at least one concavity: tapers downwardly from the first region of the upper exterior surface towards the third region of the upper exterior surface; and, has at least one indentation for receiving a palm and a thumb from a hand of an operator.

In yet other embodiments, a vertical support assembly attached to the base of the body portion. In some of those embodiments, the vertical support assembly is attached to the at least one side of the base of the body portion. In other embodiments, the vertical support assembly is attached to the underside of the base of the body portion.

In yet other embodiments, the attachment means for fixably attaching the body portion to the at least one support structure of a crutch, a walker, a cane, or other ambulatory device is a clamp. In other embodiments, the attachment means is an elongated element with at least one position-securing means for holding the elongated element in a fixed position relative to the at least one support structure of the crutch, the walker, the cane or the other ambulatory device.

In some of those embodiments, the elongated element has a first apertured end, a second apertured end, and a second longitudinal axis extending through an aperture extending between the first apertured end and the second apertured end. In yet further embodiments, the at least one position securing means is a nut and bolt combination.

This invention includes a method for travelling along a walking surface. The method consists of: (1) positioning the operator in contact with an apparatus of this invention; (2) the operator grasping the body portion of this invention; (3) the operator placing the base of a hand on the apparatus; (4) the operator supporting oneself with the palm region of a hand; and, (5) the operator leaning on the apparatus while walking.

The main object of this invention is to provide an alternative to conventional hand grips employed on crutches, canes and walkers. By having an apparatus that employs the heel of an operator's hands, as opposed to transferring force through the web area between the thumb and forefinger, force is transferred through the wrist to the radius and ulna directly, the object of minimizing damage to the nerves, muscles, tendons and other tissue of the of the hand, wrist and arm is better attained.

This invention addresses the problems which frequently arise pertaining to an operator's use of hand grips for crutches, walkers, canes and other ambulatory devices.

The primary advantage of this invention is in being a cost-effective and improved hand grip for ambulation aids, such as crutches, walkers, and canes. This invention employs a differently-positioned contact area for an operator's hands to engage an ambulation device, such as crutches, walkers, canes and other ambulatory devices. The apparatus and method of this invention provides relief for the muscles of the web of the hand, as well as minimizing the tensional stress on the tendons, and avoiding the misalignment of the wrist and arms.

These and other objects and advantages of the present invention, as well as details of the preferred embodiment, and other embodiments thereof, will be more fully understood from the following description and drawings.

### 6. BRIEF DESCRIPTION OF THE DRAWINGS

FIG. 1 is a diagram showing an oblique view of the apparatus for the right hand illustrating the relationship of the elements of the invention.

FIG. 2 is a side view of the apparatus for the right hand.

FIG. 3 is a top view of the apparatus for the right hand.

FIG. 4 is a front view of the apparatus for the right hand.

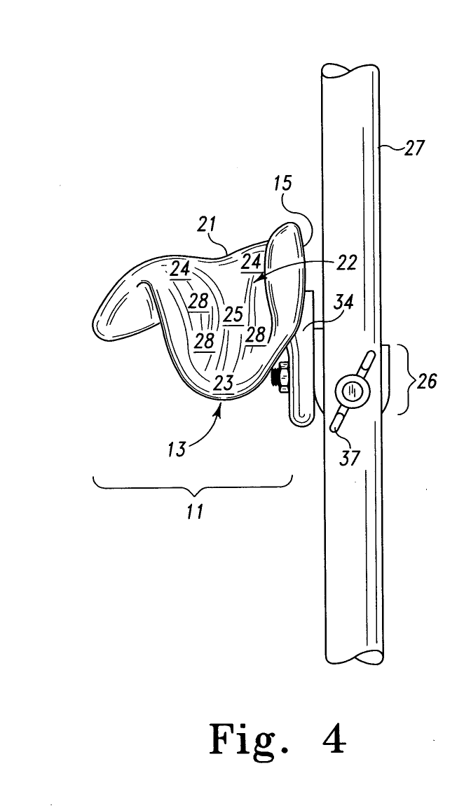

FIG. 5 is a bottom view of the apparatus for the right hand.

FIG. 6 is an end view of the apparatus for the right hand.

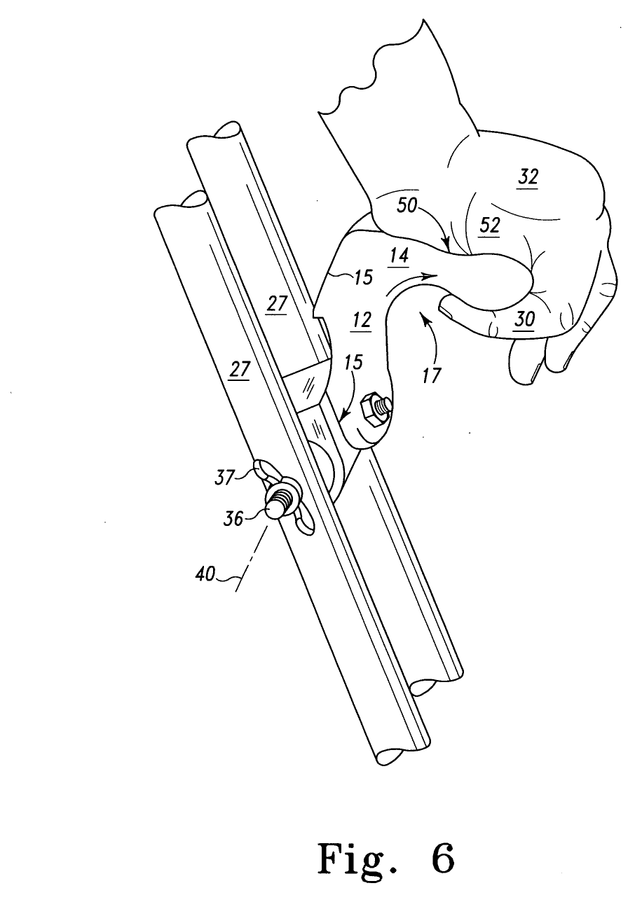

### 7. DESCRIPTION OF CERTAIN PREFERRED EMBODIMENTS

This invention is an improved hand grip, for a crutch, a walker, a cane and other ambulatory device. The invention consists of a body portion (11) with a base (12), an upper exterior surface (18), a generally convex region (24) at least one concavity (25), and an attachment means (26) to attach the invention to at least one support structure (27) of a crutch, a walker, a cane, or other ambulatory device.

In one embodiment of the invention, as illustrated in the drawings, this invention employs a body portion (11) with a base (12), with a front (13), a rear (14), and at least one side (15), a first longitudinal axis (16), and an underside (17). The body portion (11) further includes an upper exterior surface (18) with a first region (21) attached to the rear (14) of the base (12) and a second region (22) attached to the at least one side (15) of the base (12) and a third region (23) attached to the front (13) of the base (12). Additionally, the body portion includes a generally convex region (24) bounded by the rear (14) of the base (12), at least one side (15) of the base (12), and the front (13) of the base (12); the generally convex region (24) also includes the first region (21) of the upper exterior surface (18), the second region (22) of the upper exterior surface (18) and the third region (23) of the upper exterior surface (18).

On the upper exterior surface (18) of the body portion (11) is located at least one concavity (25). The at least one concavity (25) is on the upper exterior surface (18) between the first region (21) of the upper exterior surface (18), and the second region (22) of the upper exterior surface (18) and the third region (23) of the upper exterior surface (18).

The invention further includes an attachment means (26) attached to the base (12) for fixably attaching the body portion (11) to at least one support structure (27) of a crutch, a walker, a cane, or other ambulatory device.

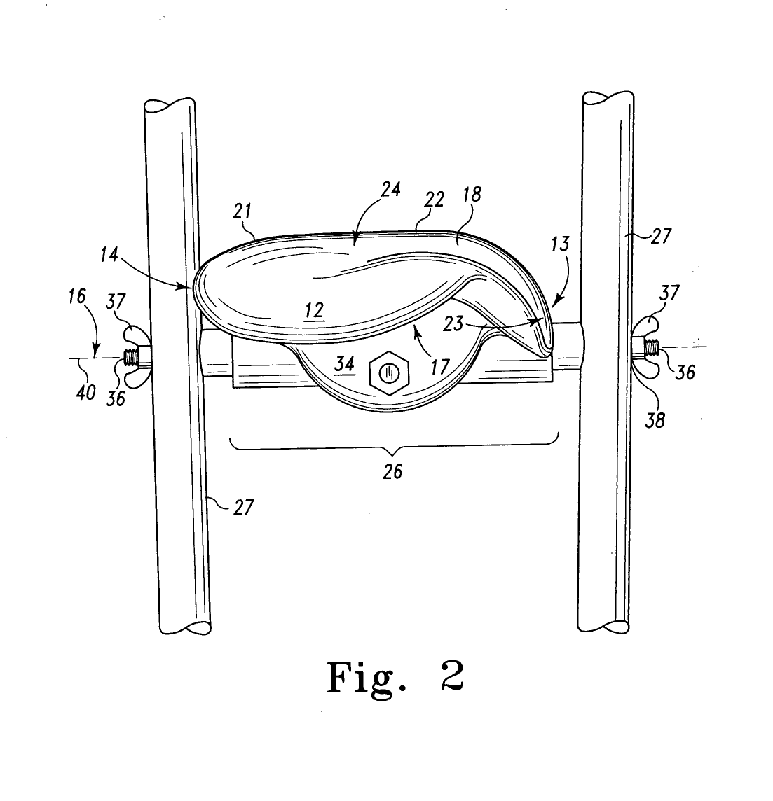

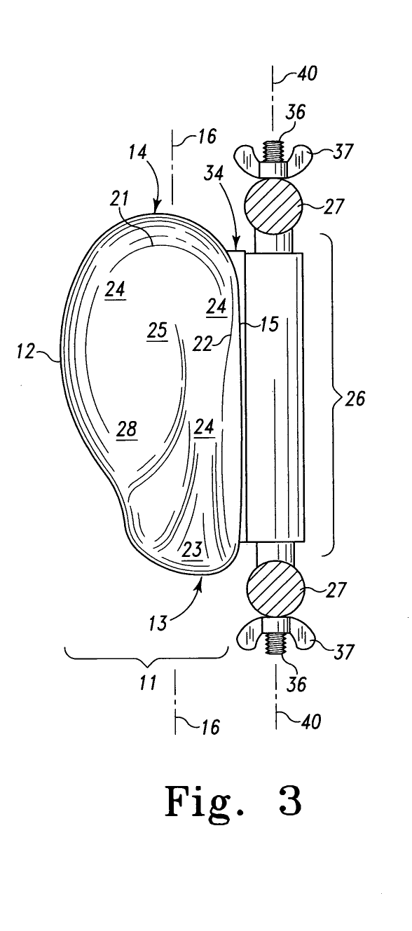

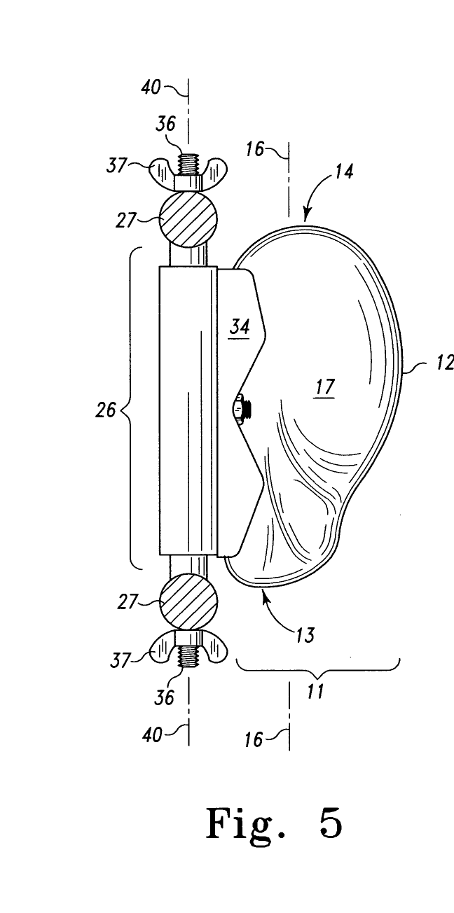

In another embodiment of the invention, the base (12) is elongated along the first longitudinal axis (16). The elongation of the axis is illustrated in the side view of FIG. 2 and the top view of FIG. 3, as well as the bottom view of FIG. 5 of the drawings.

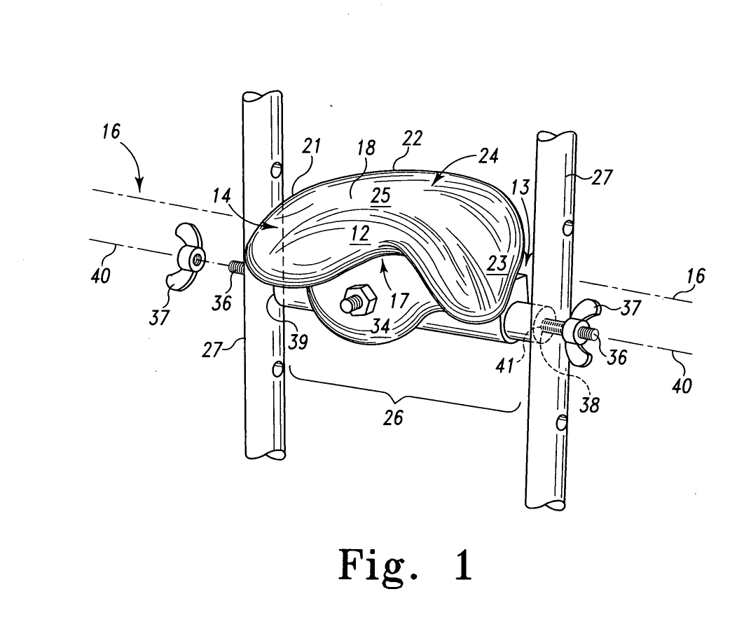

In another embodiment of the invention, the underside (17) of the base (12) of the body portion (11) is contoured. As illustrated in FIGS. 1 and 2, the contour of the

Another embodiment of the invention includes a vertical support assembly (34) attached to the base (12) of the body portion (11).

In yet another embodiment of the invention which includes a vertical support assembly (34) attached to the base (12) of the body portion (11), the vertical support assembly (34) is attached to the at least one side (15) of the base (12) of the body portion (11).

In another embodiment of the invention, the attachment means (35) for fixably attaching the body portion (11) to the at least one support structure (37) of a crutch, a walker, a cane, or other ambulatory device is a clamp (44).

In another embodiment of the invention, and as illustrated by the drawings, the attachment means (35) is an elongated element (36) with at least one position-securing means (37) for holding the elongated element (36) in a fixed position to the at least one support structure (27) of the crutch, the walker, the cane, or the other ambulatory device.

In yet another embodiment of the invention wherein the attachment means (35) is an elongated element (36) with at least one position-securing means (37) for holding the elongated element (36) in a fixed position, the elongated element (36) has a first apertured end (38), a second apertured end (39), and a second longitudinal axis (40). In one embodiment, the second longitudinal axis (40) is generally parallel to the first longitudinal axis (16). The second longitudinal axis (40) extends through an aperture (41), which itself, extends between the first apertured end (38) and the second apertured end (39).

In yet another embodiment of the apparatus, the at least one position securing means (37) is a nut (42) and bolt (43) combination.

The method of this invention includes positioning the operator (31) in contact with an apparatus (10) of this invention. The operator (31) grasps the body portion (11) defined by the apparatus (10), which is attached to one of the at least one support structure (27) of a crutch, a walker, a cane or other ambulatory device. By placing the base (52) of a hand (32) on the apparatus (10), the operator (31) is supported by the heel (53) of the palm (50) region of the hand (32), while the operator (31) leans on the body portion (11) of the apparatus (10) while walking.

I claim:

1. A hand grip for a crutch, a walker, a cane and other ambulatory device, comprising:
a body portion, with
a base, with a front, a rear, at least one side, a first longitudinal axis, and an underside
an upper exterior surface with a first region attached to the rear of the base and a second region attached to the at least one side of the base, and
a third region attached to the front of the base, and,
a generally convex region
bounded by the rear of the base, at least one side of the base, and the front of the base, and
including the first region of the upper exterior surface, the second region of the upper exterior surface and the third region of the upper exterior surface, and
at least one concavity on the upper exterior surface between the first region of the upper exterior surface, the second region of the upper exterior surface, and the third region of the upper exterior surface, and
at least one attachment means attached to the base for fixably attaching the body portion to at least one support structure of a crutch, a walker, a cane or other ambulatory device.

2. The apparatus of claim 1, wherein
the base is elongated along the first longitudinal axis.

3. The apparatus of claim 1, wherein
the underside of the base of the body portion is contoured.

4. The apparatus of claim 1, wherein
the underside of the base is contoured to receive at least one finger of an operator.

5. The apparatus of claim 1, wherein
the at least one concavity tapers downwardly from the first region of the upper exterior surface towards the third region of the upper exterior surface.

6. The apparatus of claim 1, wherein
the at least one concavity on the upper exterior surface has at least one indentation for receiving a palm and a thumb from a hand of an operator.

7. The apparatus of claim 1 further comprising
a vertical support assembly attached to the base of the body portion.

8. The apparatus of claim 7, wherein
the vertical support assembly is attached to the at least one side of the base of the body portion.

9. The apparatus of claim 7, wherein
the vertical support assembly is attached to the underside of the base of the body portion.

10. The apparatus of claim 1, wherein
the at least one attachment means for fixably attaching the body portion to the at least one support structure of a crutch, a walker, a cane, or other ambulatory device is a clamp.

11. The apparatus of claim 1, wherein
the at least one attachment means is an elongated element with at least one position-securing means for holding the elongated element in a fixed position relative to the at least one support structure of the crutch, the walker, the cane or the other ambulatory device.

12. The apparatus of claim 11, wherein
the elongated element has
a first apertured end,
a second apertured end, and
a second longitudinal axis extending through an aperture extending between the first apertured end and the second apertured end.

13. The apparatus of claim 12, wherein
the second longitudinal axis generally parallel to the first longitudinal axis.

14. The apparatus of claim 12, wherein
the at least one position securing means is a nut and bolt combination.

15. A hand grip for a crutch, a walker, a cane and other ambulatory device, for an operator with a hand, a palm, a thumb and a finger comprising:
a body portion, with
an elongated base, with a front, a rear, at least one side, a first longitudinal axis, and a contoured underside to receive at least one finger of the operator
an upper exterior surface with a first region attached to the rear of the base and a second region attached to the at least one side of the base, and
a third region attached to the front of the base, and,
a generally convex region
bounded by the rear of the base, at least one side of the base, and the front of the base, and
including the first region of the upper exterior surface, the second region of the upper exterior surface and the third region of the upper exterior surface, and
at least one concavity on the upper exterior surface between the first region of the upper exterior surface, the second region of the upper exterior surface, and the third region of the upper exterior surface, wherein the at least one concavity
tapers downwardly from the first region of the upper exterior surface towards the third region of the upper exterior surface, and includes at least one indentation for receiving the palm and thumb of the hand of the operator, and
at least one attachment means attached to the base for fixably attaching the body portion to at least one support structure of a crutch, a walker, a cane or other ambulatory device wherein the at least one attachment means is an elongated element with at least one position-securing means for holding the elongated element in a fixed position relative to the at least one support structure of the crutch, the walker, the cane or the other ambulatory device and the elongated element has
a first apertured end,
a second apertured end,
a second longitudinal axis extending through an aperture extending between the first apertured end and the second apertured end, and
the at least one position securing means is a nut and bolt combination.

16. A method for travelling along a walking surface, the method comprising:
positioning the operator in contact with an apparatus comprising
a body portion, with
a base, with a front, a rear, at least one side, a first longitudinal axis, and an underside
an upper exterior surface with a first region attached to the rear of the base and a second region attached to the at least one side of the base, and a third region attached to the front of the base, and,
a generally convex region
bounded by the rear of the base, at least one side of the base, and the front of the base, and
including the first region of the upper exterior surface, the second region of the upper exterior surface and the third region of the upper exterior surface, and
at least one concavity on the upper exterior surface between the first region of the upper exterior surface, the second region of the upper exterior surface, and the third region of the upper exterior surface, and
an attachment means attached to the base for fixably attaching the body portion to at least one support structure of a crutch, a walker, a cane or other ambulatory device,
whereby the body portion is grasped so that the attachment means is fixably attached to one of the at least one support structure of a crutch, a walker, a cane or other ambulatory device,
placing the base of a hand of the operator on the apparatus, the operator supporting himself with the palm region of a hand, the operator leaning on the body portion of the apparatus while walking.
